(19) United States
(12) Patent Application Publication
(10) Pub. No.: US 2014/0081833 A1
(43) Pub. Date: Mar. 20, 2014

(54) SYSTEMS AND METHODS OF MONETIZING DEBT

(71) Applicants: Jonathan Koop, Scottsdale, AZ (US); Shawn Mulligan, Worcester, MA (US)

(72) Inventors: Jonathan Koop, Scottsdale, AZ (US); Shawn Mulligan, Worcester, MA (US)

(21) Appl. No.: 13/835,172

(22) Filed: Mar. 15, 2013

Related U.S. Application Data
(60) Provisional application No. 61/703,402, filed on Sep. 20, 2012.

(51) Int. Cl. G06Q 40/02

(52) U.S. Cl. CPC G06Q 40/025
USPC 705/38

(57) ABSTRACT

According to one aspect, a computer system is provided. The computer system comprising a memory, at least one processor coupled to the memory, an account data interface component executed by the at least one processor and configured to receive account information for accounts owned by a plurality of distinct parties, a scrubbing engine component executed by the at least one processor and configured to identify a plurality of high risk debt accounts described within the account information, and a purchasing engine component executed by the at least one processor and configured to identify at least one high risk debt account of the plurality of high risk debt accounts with an estimated return sufficient to warrant purchasing the at least one high risk debt account.

### RELATED APPLICATIONS

This application claims priority under 35 U.S.C. §119(e) to U.S. Provisional Application Ser. No. 61/703,402, entitled “SYSTEMS AND METHODS OF MONETIZING DEBT,” filed on Sep. 20, 2012, which is hereby incorporated herein by reference in its entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND

1. Technical Field

Embodiments disclosed herein relate generally to debt acquisition systems and, more particularly, to systems and processes of monetizing high risk debt.

2. Discussion

Conventional approaches to the monetization of debt heavily favor sellers and buyers of large portfolios of debt accounts over sellers and buyers of smaller portfolios. Due to inherent economies of scale, large volume sellers of debt accounts, such as banks and credit card companies, tend to bundle together large portfolios of debt accounts and sell these portfolios for large sums of money. Given this high cost supply, only well-funded buyers of debt accounts are in a position to purchase. These large buyers often seek to collect the debt through in-house collectors or by outsourcing the collections to collection agencies who, in turn, repackage the debt in smaller regions for resale. Thus, under the conventional debt purchasing markets, it is difficult to buy selected debt, such as specific accounts, from a seller.

Moreover, given this volume-centric marketplace, it is difficult for creditors holding relatively modest amounts of bad debt to monetize the debt. Engaging the services of a conventional debt collector includes inherent inefficiencies. For example, debt collectors tend to focus on collecting only a small percentage of the overall debt placed with them (i.e., the debt they consider to be the most likely for collected). Thus much of the debt placed with collectors remains uncollected.

### SUMMARY

In broad overview, at least some aspects and embodiments disclosed herein are directed to systems and methods that locate, extract, evaluate, and liquidate non-typical types of debt (i.e., debt that is not collected according to standard business and legal practices in the debt collection industry). Some aspects disclosed herein provide a facility for the monetization of debt. For example, according to one aspect, a computer system enables owners of high risk debt to sell the debt to a purchaser. According to another aspect, a computer system enables the purchaser to liquidate the debt. Further, at least one aspect provides for a computer system configured to leverage potential efficiencies created by the computer system during its assembly of a collection of debt from a two or more distinct debt owners. According to this aspect, the computer system receives account information from a plurality of owners, scrubs the account information to identify high risk debt accounts, such as deceased accounts (i.e., accounts of debt incurred by deceased parties), bankrupt accounts (i.e. accounts subject to bankruptcy proceedings), debt settlement accounts (i.e. accounts of debt incurred by parties working with a debt settlement company), unclaimed funds accounts (i.e. abandoned accounts), cease and desist accounts (i.e. accounts of debt incurred by parties subject to a cease and desist order), and incarcerated accounts (i.e., accounts of debt incurred by parties who are incarcerated) and facilitates a transfer of ownership of the high risk debt accounts from the owner to the purchaser in exchange for compensation. Also, according to this aspect, the computer system facilitates collecting on or selling the high risk debt accounts purchased by the purchaser. By processing high risk debt accounts acquired from a plurality of owners in the aggregate, the computer system creates economies of scale that enable profitable disposition of debt that individual owner are not able to dispose of profitability using conventional technology.

In some contexts, during the initial formation of a relationship between the purchaser and each debt owner, the purchaser may execute a master agreement with the debt owner in which the purchaser agrees to periodically evaluate a portfolio of debt for high risk debt accounts and in which the owner agrees to sell, to the purchaser, any identified high risk debt accounts that meet a set of predefined criteria for a specified amount of compensation. This master agreement may further specify that each purchase be memorialized using particular purchase documents (e.g. a purchase and sale agreement).

According to one aspect, a computer system is provided. The computer system comprising a memory, at least one processor coupled to the memory, an account data interface component executed by the at least one processor and configured to receive account information for accounts owned by a plurality of distinct parties, a scrubbing engine to component executed by the at least one processor and configured to identify a plurality of high risk debt accounts described within the account information, and a purchasing engine component executed by the at least one processor and configured to identify at least one high risk debt account of the plurality of high risk debt accounts with an estimated return sufficient to warrant purchasing the at least one high risk debt account.

According to one embodiment, the scrubbing engine component is further configured to associate each of the plurality of high risk debt accounts with at least one respective debt account type. According to one embodiment, the purchasing engine component is further configured to compute the estimated return using the debt account type associated with the at least one high risk debt account. According to one embodiment, the debt account type is at least one of a bankrupt account type, a deceased account type, debt settlement account type, an unclaimed funds account type, a cease and desist account type and an incarcerated account type. According to one embodiment, the purchasing engine component is further configured to, responsive to identifying the at least one high risk debt account, automatically generate purchase documents including information descriptive of at least one of the plurality of distinct parties who owns the at least one high risk debt account and provide the purchase documents to an external entity for subsequent processing. According to one embodiment, the account data interface component is configured to receive the account information from a plurality of external entities via a network.

According to one embodiment, the system further comprising a liquidation engine component configured to automatically generate and transmit claim documents to an external entity. According to one embodiment, the account data interface component is further configured to identify previously purchased high risk debt accounts of the plurality of high risk debt accounts and exclude the previously purchased high risk debt accounts from subsequent processing.

According to one aspect, a method of monetizing high risk debt using a computer system is provided. The method comprising receiving, by the computer system, account information for accounts owned by a plurality of distinct parties, identifying a plurality of high risk debt accounts described within the account information, and identifying at least one high risk debt account of the plurality of high risk debt accounts with an estimated return sufficient to warrant purchasing the at least one high risk debt account.

According to one embodiment, the method further comprises associating each of the plurality of high risk debt accounts with at least one respective debt account type. According to one embodiment, the method further comprises computing the estimated return using the debt account type associated with the at least one high risk debt account. According to one embodiment, associating each of the plurality of high risk debt accounts with at least one respective debt account type includes associating each of the plurality of high risk debts accounts with at least one of a bankrupt account type, a deceased account type, debt settlement account type, an unclaimed funds account type, a cease and desist account type and an incarcerated account type. According to one embodiment, the method further comprises generating, automatically in response to identifying the at least one high risk debt account, purchase documents including information descriptive of at least one of the plurality of distinct parties who owns the at least one high risk debt account, and providing the purchase documents to an external entity for subsequent processing. According to one embodiment, receiving the account information includes receiving account information from a plurality of external entities via a network. According to one embodiment, the method further comprises generating claim documents, and transmitting the claim documents to an external entity. According to one embodiment, the method further comprises identifying previously purchased high risk debt accounts of the plurality of high risk debt accounts, and excluding the previously purchased high risk debt accounts from subsequent processing.

According to one aspect, a non-transitory computer readable medium storing instructions executable by at least one processor to perform a method of monetizing high risk debt is provided. The instructions instructing the at least one processor to receive account information for accounts owned by a plurality of distinct parties, identify a plurality of high risk debt accounts described within the account information, and identify at least one high risk debt account of the plurality of high risk debt accounts with an estimated return sufficient to warrant purchasing the at least one high risk debt account.

According to one embodiment, the instructions further instruct the at least one processor to associate each of the plurality of high risk debt accounts with at least one respective debt account type. According to one embodiment, the instructions further instruct the at least one processor to compute the estimated return using the debt account type associated with the at least one high risk debt account. According to one embodiment, the instructions to associate each of the plurality of high risk debt accounts with at least one respective debt account type include instructions that instruct the at least one processor to associate each of the plurality of high risk debts accounts with at least one of a bankrupt account type, a deceased account type, debt settlement account type, an unclaimed funds account type, a cease and desist account type and an incarcerated account type.

Still other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 is a context diagram of a debt monetization system;

FIG. 2 is a schematic diagram of the debt monetization system illustrated in FIG. 1;

FIG. 3 is a schematic diagram of one example of a computer system that may perform processes and functions disclosed herein;

FIG. 4 is a flow diagram illustrating a process of monetizing high risk debt accounts;

FIG. 5 is a flow diagram illustrating a process of identifying high risk debt accounts;

FIG. 6 is a flow diagram illustrating a process of purchasing high risk debt accounts;

FIG. 7 is a flow diagram illustrating a process of monetizing purchased high risk debt accounts

FIG. 8 is an exemplary set of user interface elements provided by at least one of the embodiments;

FIG. 9 is an exemplary set of user interface elements provided by at least one of the embodiments;

FIG. 10 is an exemplary set of user interface elements provided by at least one of the embodiments;

FIG. 11 is an exemplary set of user interface elements provided by at least one of the embodiments;

FIG. 12 is an exemplary set of user interface elements provided by at least one of the embodiments;

FIG. 13 is an exemplary set of user interface elements provided by at least one of the embodiments; and

FIG. 14 is an exemplary set of user interface elements provided by at least one of the embodiments.

### DETAILED DESCRIPTION

Some of the aspects and embodiments disclosed herein describe new apparatus and processes for monetizing high risk debt accounts, such as receivables owed to a creditor by a deceased debtor or a debtor subject to bankruptcy proceedings. For example, according to some embodiments, a computer system includes and executes components that enable an owner of high risk debt to sell the debt to a purchaser. In other embodiments, a computer system includes and executes components that enable the purchaser to evaluate and collect on, or sell, the purchased debt. The computer system benefits both the owners and the purchasers by increasing the profits gained by these parties relative to conventional approaches to debt monetization.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples or embodiments are not intended to be excluded from a similar role in any other examples or embodiments.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

### Debt Processing System

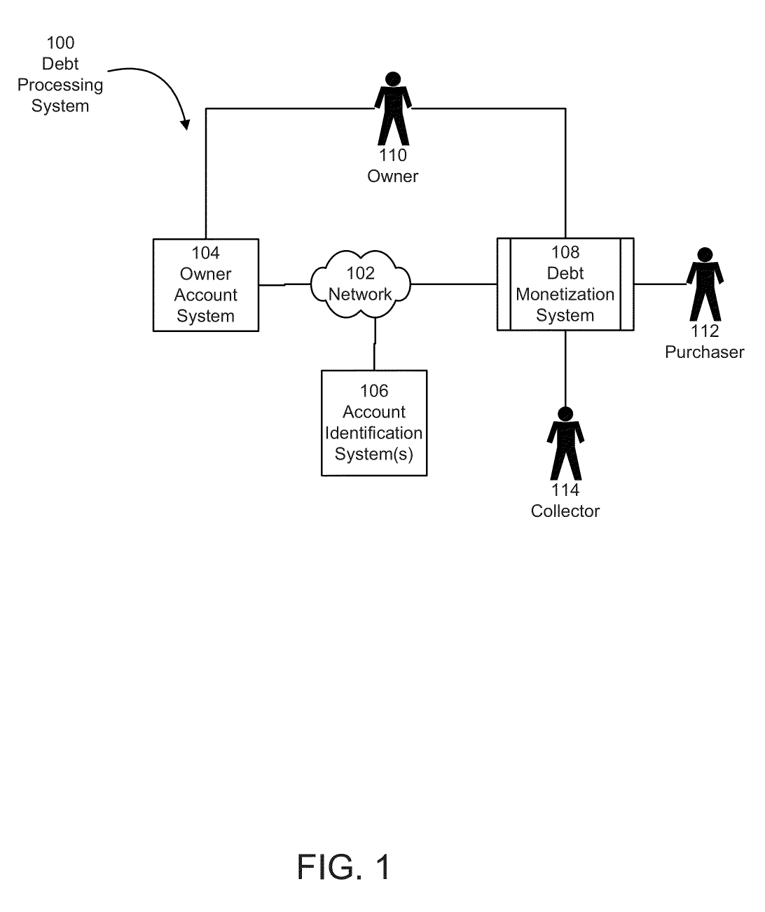

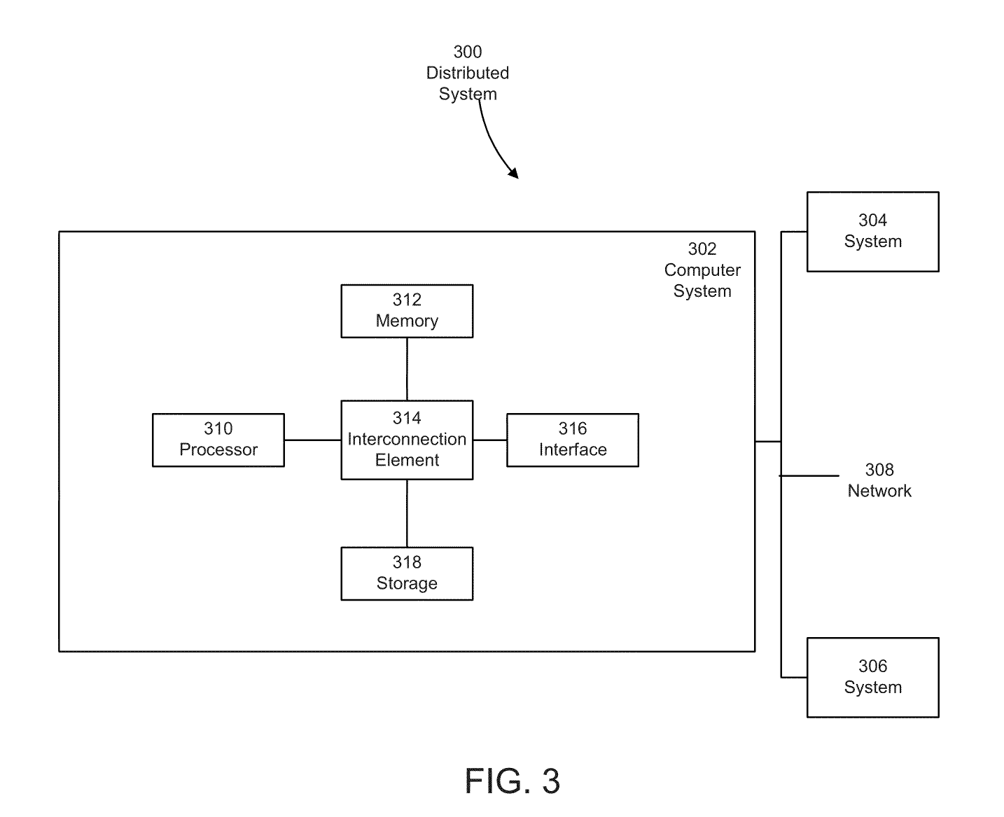

Some embodiments disclosed herein implement a debt processing system using one or more computer systems, such as the computer systems described below with reference to FIG. 3. According to these embodiments, a debt monetization system receives, scrubs, and transfers ownership of high risk debt in exchange for compensation. FIG. 1 illustrates an exemplary debt monetization system 108 within the context of an exemplary debt processing system 100. As shown in FIG. 1, the debt processing system 100 includes a communication network 102, an owner account system 104, one or more account identification systems 106, the debt monetization system 108, one or more debt account owners 110, one or more debt purchasers 112, and one or more debt collectors 114. In the example illustrated in FIG. 1, the owner account system 104, the account identification system 106, and the debt monetization system 108 each include one or more computer systems. The owner account system 104 exchanges (provides or receives) information with the owner 110 via one or more user interfaces. Similarly, the debt monetization system 108 exchanges information with the collector 114, the purchaser 112, and the owner 110 via one or more user interfaces.

As depicted in FIG. 1, the owner account system 104, the account identification system 106, and the debt monetization system 108 exchange (i.e. transmit or receive) information via the network 102. The network 102 may include any communication network through which computer systems exchange information. For example, the network 102 may be a public network, such as the internet, and may include other public or private networks such as LANs, WANs, extranets, intranets, and cloud computing systems. Although shown as a single network in FIG. 1, in some embodiments, the network 102 includes a plurality of communication networks.

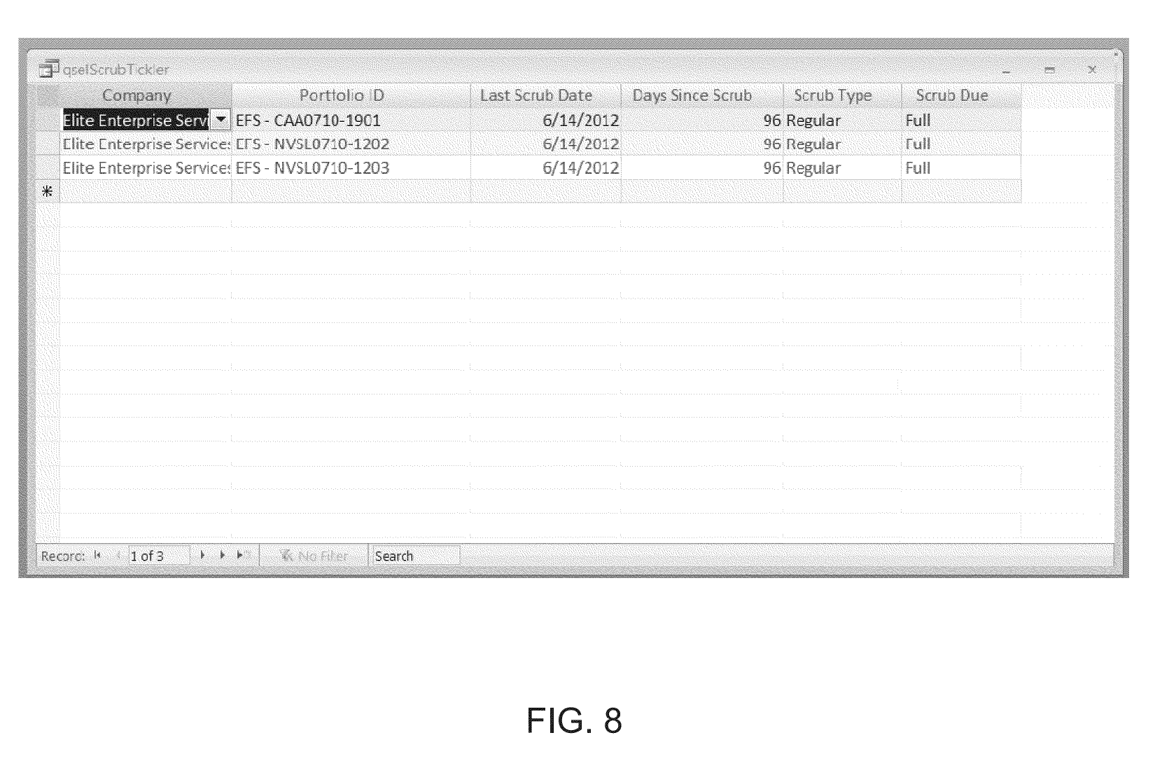

In the embodiment illustrated in FIG. 1, the debt monetization system 108 is configured to implement one or more user interfaces. These user interfaces may be implemented via the network 120. For example, in some embodiments illustrated by FIG. 1, the debt monetization system 108 serves one or more browser-based user interfaces to devices (such as computer systems) operated by the owner, 110, the purchaser 112, and the collector 114. In other embodiments, the debt monetization system 108 implements specialized client programs that execute outside of a browser environment, such as an application program executing on a mobile device or other computer system. The user interfaces may incorporate a variety of additional technologies and may include sundry elements (e.g., screens, windows, buttons, boxes, etc) arranged according to various user interface metaphors. FIGS. 8-14 illustrate exemplary sets of user interface elements provided according to at least one embodiment.

In the embodiment shown in FIG. 1, the debt monetization system 108 exchanges account information with the owner account system 104. Examples of commercially available software that may be employed to create the owner account system 104 include the BEAM system, commercially available from Beam Software of Lakewood Ranch, Fla. and cost and financial accounting systems such as SAP commercially available from SAP AG of Walldorf, Germany; ENTERPRISEONE commercially available from Oracle Corporation of Redwood City, Calif.; and QUICKBOOKS commercially available from Intuit of Palo Alto, Calif., and the like. The information exchanged between the debt monetization system 108 and the owner account system 104 may include data descriptive of accounts owned by the owner 110. Thus the information exchanged may include data descriptive of a debtor (e.g. name, social security number, address, type of legal entity, etc.), an account balance, transactions posted to the account (including transaction amount and transaction date), and the like. As described further below, in some embodiments, the debt monetization system 108 is configured to store and utilize this information to identify and value high risk debt accounts included within portfolios of accounts.

In other embodiments, the debt monetization system 108 exchanges identification information with the account identification system 106. Examples of commercially available account identification systems include the Skip Tracing system available from Interactive Data of Duluth, Ga.; the Batch Solutions system available from Lexis Nexis of Dayton, Ohio; Debt Settlement Infobank available from Debt Settlements of Austin, Tex.; and the like. Other examples of account identification systems include government records systems that include information descriptive of criminal, civil, bankruptcy and probate cases. The information exchanged between the debt monetization system 108 and the account identification system 106 may include data descriptive accounts owned by the owner 110 or information indicating that the debtor is subject to court case, such as a bankruptcy or probate case. In some embodiments, the account identification system 106 receives account information from the debt monetization system 108, identifies high risk accounts described in the account information, and provides information identifying the high risk accounts to the debt monetization system 108.

Information may flow between the components illustrated in FIG. 1, or any of the elements, components and subsystems disclosed herein, using a variety of techniques. Such techniques include, for example, passing the information over a network using standard protocols, such as TCP/IP, HTTP, or HTTPS, passing the information between modules in memory and passing the information by writing to a file, database, data store, or some other nonvolatile data storage device, among others. In addition, pointers or other references to information may be transmitted and received in place of, in combination with, or in addition to, copies of the information. Conversely, the information may be exchanged in place of, in combination with, or in addition to, pointers or other references to the information. Other techniques and protocols for communicating information may be used without departing from the scope of the examples and embodiments disclosed herein.

### Debt Monetization System

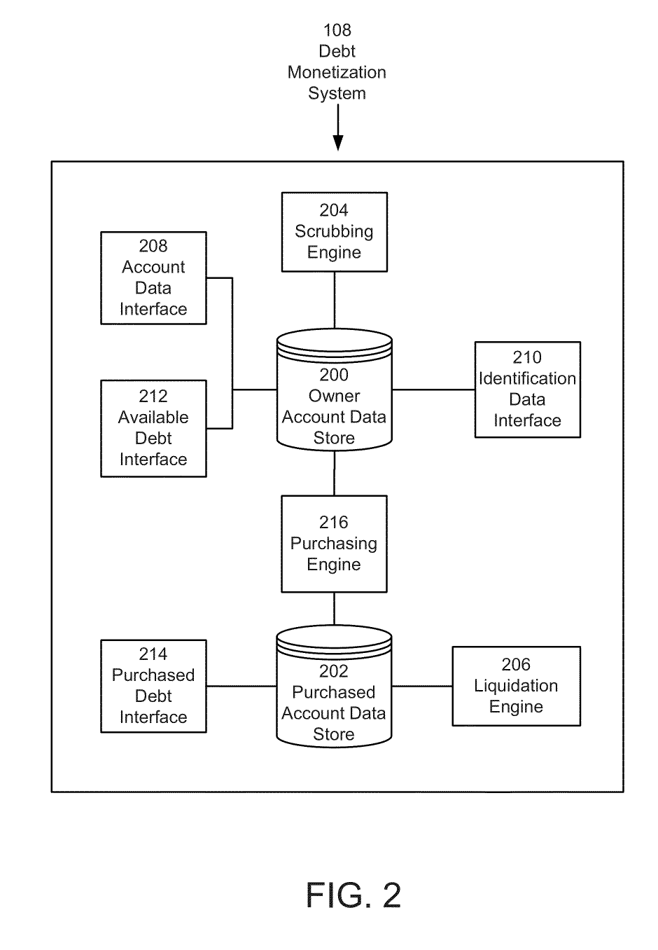

The debt monetization system 108 may be configured according to a variety of architectures. FIG. 2 illustrates one such architecture. The architecture illustrated in FIG. 2 is provided for exemplary purposes only and embodiments disclosed herein are not limited to the architecture shown in FIG. 2. For example, in some of the embodiments, the physical components described below may be virtualized. In other examples, the logical components described below may be implemented as specialized computer hardware or a combination of computer hardware and software.

As depicted in FIG. 2, the debt monetization system 108 is implemented using a computer system, such as any of the computer systems described below with reference to FIG. 3. The debt monetization system 108 includes nine logical components: an owner account data store 200, a purchased account data store 202, a scrubbing engine 204, a liquidation engine 206, an account data interface 208, an identification data interface 210, an available debt interface 212, a purchased debt interface 214, and a purchasing engine 216.

In the embodiment illustrated in FIG. 2, the debt monetization system 108 executes the account data interface 208, the identification data interface 210, the available debt interface 212, and the purchased debt interface 214. Each of these interfaces may exchange information with a variety of external entities, such as users or external systems. For example, according to one embodiment, the available debt interface 212 is configured to serve a browser-based user interface to the owner 110, the purchaser 112, or the collector 114 that is rendered as a user interface by a web browser. The purchased debt interface 214 may also be configured to serve browser-based user interfaces to the owner 110, the purchaser 112, or the collector 114. In other embodiments, the account data interface 208 is configured to exchange account information with an external system, such as the owner account system 104. In at least one of these embodiments, the identification data interface 210 is configured to exchange identification information with an external system, such as the account identification system 106. In exchanging information, the account data interface 208, the identification data interface 210, the available debt interface 212, and the purchased debt interface 214, may exchange files and other information with one or more FTP sites accessible by a variety of users, such as the owner 110, the purchaser 112, and the collector 114.

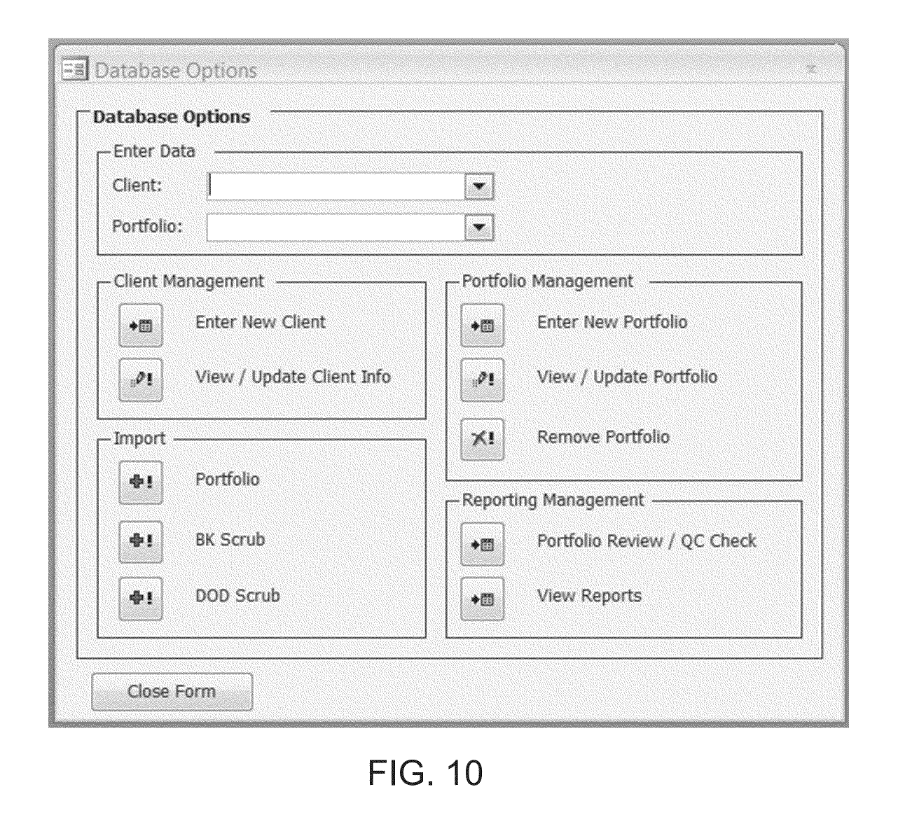

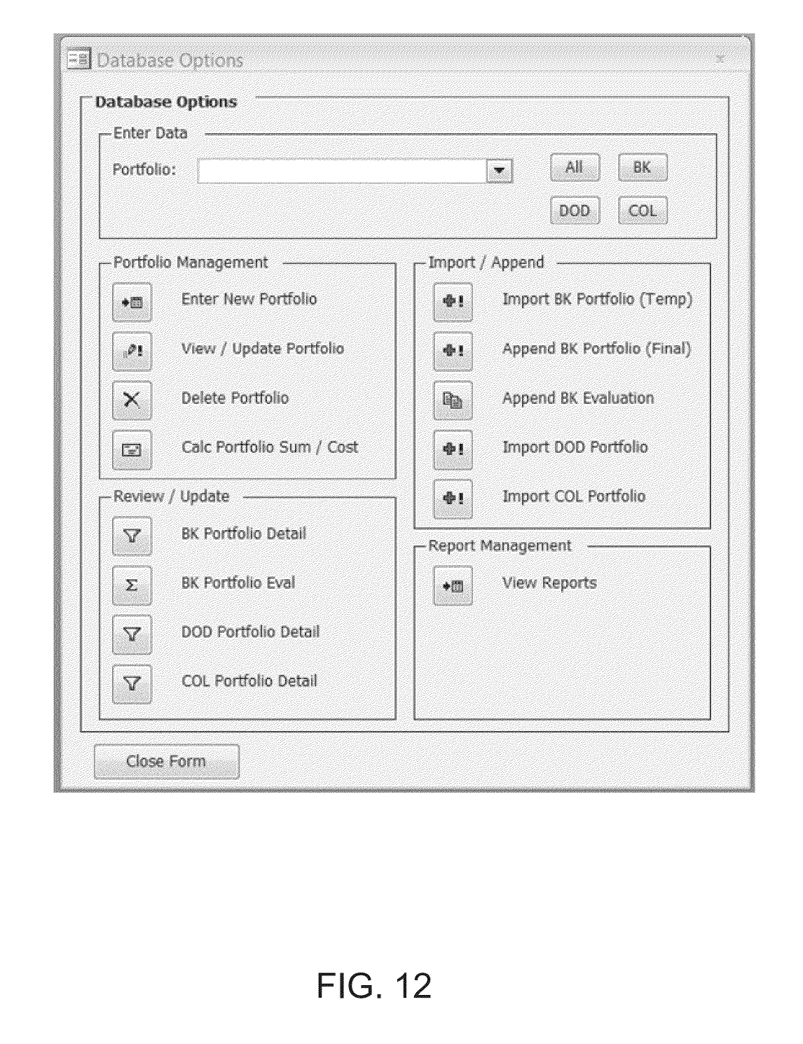

In addition, in at least some embodiments, one or more of the interfaces 208, 210, 212, and 214 exchange information with specialized client programs that execute outside of a browser environment, such as an application program executing on a mobile device or other computer system, to provide interface elements to users. For example, FIG. 10 illustrates one example of a set of user interface elements provided by the available debt interface 212. FIG. 12 illustrates one example of a set of user interface elements provided by the purchased debt interface 214. Both of these examples are described further below.

According to one embodiment, the account data interface 208 receives account information from the owner account system 104. In this embodiment, the account data interface reads the account information, verifies the quality of the account information, and stores the verified account information in the owner account data store 200. While executing this verification process, the account data interface 208 may indentify problem accounts with no balance due, duplicate accounts numbers, duplicate social security numbers, invalid or missing state designations, missing account numbers, missing addresses, missing cities, previously purchased accounts (based on account number or social security number) and the like. In some embodiments, the account data interface 208 addresses the problem account by removing the information descriptive of the problem accounts, notifying a user of the presence of the problem accounts, tagging the problem accounts for exception handling by the system, automatically excluding the accounts from purchase processing, etc.

According to another embodiment, the available debt interface 212 is configured to receive one or more requests to configure a new debt owner and one or more portfolios owned by the debt owner. In this embodiment, the request to configure a new debt owner includes information descriptive of the debt owner's name, contact person or persons, address, phone number, bank account information, and the like. In some embodiments, responsive to receiving this owner configuration request, the available debt interface 212 stores the owner configuration request, and the information included therein, in the owner account data store 200. In addition, in this embodiment, the request to configure a new debt portfolio for an owner includes information descriptive of the name of the portfolio, the periodicity with which the portfolio should be scrubbed (e.g., one-time, every 30 days, every 60 days, every 90 days, etc.), and, optionally, the type of debt accounts (e.g. bankrupt, accounts, deceased accounts, debt settlement accounts, unclaimed funds accounts, cease and desist accounts, incarcerated accounts, and the like) included in the portfolio. In some embodiments, responsive to receiving this portfolio configuration request, the available debt interface 212 stores the portfolio configuration request, and the information included therein, in the owner account data store 200.

According to another embodiment, the available debt interface 212 is configured to provide information descriptive of debts available for purchase within the debt monetization system 108. In this embodiment, the available debt interface 212 exchanges debt information with the purchaser 112. The information exchanged between the available debt interface 212 and the purchaser 112 may include search requests and search responses. Search requests specify the characteristics of debts targeted by the search request. Search responses include information descriptive of debts having the characteristics specified in a search request corresponding to the search response. In some embodiments, responsive to receiving a search request, the available debt interface 212 retrieves, from the owner account data store 200, information descriptive of the debts having the characteristics specified in the search criteria and provides this information to the purchaser 112.

According to another embodiment, the available debt interface 212 is configured to receive one or more requests to purchase debt from the purchaser user interface 108. In this embodiment, the purchase request may include information (e.g., an account number or portfolio name) that identifies one or more high risk debt accounts that the purchaser wishes to purchase. In some embodiments, responsive to receiving the purchase request, the available debt interface 212 stores the purchase request, and the information included therein, in the owner account data store 200. Further, in these embodiments, responsive to receiving the purchase request, the available debt interface 212 may request execution of the purchasing engine 216 to initiate execution of the purchase request.

According to another embodiment, the available debt interface 212 is configured to receive one or more requests to update the classification of one or more debt accounts stored in the owner account data store 200. In this embodiment, the update request includes information descriptive of the account, accounts, or portfolios to which the update request is directed. In some embodiments, responsive to receiving this update request, the available debt interface 212 stores the update request, and the information included therein, in the owner account data store 200.

In other embodiments, the available debt interface 212 also requests that the scrubbing engine 202 re-execute one or more processes in response to receiving the update request. For example, in one embodiment, the available debt interface 212 may request that the scrubbing engine 202 re-execute act 508, which is described further below. In another embodiment, the available debt interface 212 may request that the scrubbing engine 202 re-determine the group or groups to which high risk debt accounts belong. Classification of the high risk debt accounts into groups is described further below with reference to the act 508. In still another embodiment, the available debt interface 212 may request that the scrubbing engine 202 re-identify high risk debt accounts included within the owner account data store 200.

According to another embodiment, the available debt interface 212 is configured to receive one or more reporting requests. The reporting request may include information descriptive of a report and parameters used to run the report. In some embodiments, responsive to receiving the report request, the available debt interface 212 executes the reporting request by retrieving data from the owner account data store 200, formatting the data according to the report format, and presenting the report via a user interface.

Some examples of reports that may be requested include a scrub due report, a vendor import files report, a full portfolio report, a bankruptcy—all report, a deceased—all report, a debt settlement—all report, an unclaimed funds—all report, a cease and desist—all report, an incarcerated—all report, a bankruptcy eligible report, a deceased eligible report, a debt settlement eligible report, an unclaimed funds eligible report, a cease and desist eligible report, an incarcerated eligible report, a portfolio bankruptcy eligible report, a portfolio deceased eligible report, a portfolio debt settlement eligible report, a portfolio unclaimed funds eligible report, a portfolio cease and desist eligible report, and a portfolio incarcerated eligible report. The scrub due report indicates which portfolios are due up for scrub and which level of scrub is due (e.g., full or partial). Full and partial scrubs are described further below with reference to the scrubbing engine 204 illustrated in FIG. 2. The vendor import files report is based on selected customers and portfolios and generates account information that is transmitted, via the identification data interface 210, to the account identification system for processing. The full portfolio report is based on selected customers and portfolios and outputs the entire portfolio for the selections made.

The bankruptcy—all report is based on selected customers and portfolios and outputs all bankruptcy hits for the selections made. The deceased—all report is based on selected customers and portfolios and outputs all deceased hits for the selections made. The debt settlement—all report is based on selected customers and portfolios and outputs all debt settlement hits for the selections made. The unclaimed funds—all report is based on selected customers and portfolios and outputs all unclaimed funds hits for the selections made. The cease and desist—all report is based on selected customers and portfolios and outputs all cease and desist hits for the selections made. The incarcerated—all report is based on selected customers and portfolios and outputs all incarcerated hits for the selections made.

The bankruptcy eligible report is based on selected customers and portfolios and outputs information descriptive of debt accounts identified as being subject to a bankruptcy proceeding that are eligible for purchase. The deceased eligible report is based on selected customers and portfolios and outputs information descriptive of debt accounts identified as being incurred by a deceased debtor that are eligible for purchase. The debt settlement eligible report is based on selected customers and portfolios and outputs information descriptive of debt accounts identified as being subject to a debt settlement process that are eligible for purchase. The unclaimed funds eligible report is based on selected customers and portfolios and outputs information descriptive of debt accounts identified as being abandoned that are eligible for purchase. The cease and desist eligible report is based on selected customers and portfolios and outputs information descriptive of debt accounts identified as being subject to a cease and desist order that are eligible for purchase. The incarcerated eligible report is based on selected customers and portfolios and outputs information descriptive of debt accounts identified as being incurred by an incarcerated person that are eligible for purchase.

The portfolio bankruptcy eligible report includes the information provided by the bankruptcy eligible report in a format adapted for transfer to the purchased account data store 202. The portfolio deceased eligible report includes the information provided by the deceased eligible report in a format adapted for transfer to the purchased account data store 202.

According to some embodiments, the purchased debt interface 214 is configured to provide information descriptive of purchased debts owned by the purchaser 112. In at least one embodiment, the purchased debt interface 214 provides separate user interfaces for managing each type of high risk debt (e.g., a user interface for managing debt associated with deceased persons, a separate user interface for managing debt subject to bankruptcy proceedings, a separate user interface for managing debt subject to debt settlement processes, a separate user interface for managing abandoned debt, a separate user interface for managing debt subject to cease and desist orders, and a separate user interface for managing debt incurred by incarcerated). In other embodiments, the purchased debt interface 214 provides a unified user interface with elements to exchange information regarding any type of high risk debt.

In this embodiment, the purchased debt interface 214 receives requests for debt information from the purchaser 112. These requests may include search criteria that indicate the characteristics of debts targeted by the request. These characteristics may include portfolio name, court district, account status, claims pending filing, debt settlement company, debt type, and the like. Responsive to receiving these requests, the purchased debt interface 214 may retrieve, from the purchased account data store 202, information descriptive of the purchased debts that match the search criteria and may provide this information to the purchaser 112. This information descriptive of the purchased debts may include returns associated with received with specific accounts and portfolios and forecasts of future returns from specific accounts and portfolios. Other information provided by the purchased debt interface 214 may include information descriptive of estimated returns for accounts and portfolios, variances from the estimated returns, and factors causing the variances.

In another embodiment, the purchased debt interface 214 is configured to receive requests to generate bankruptcy court filings, payments, claim notes, and other forms used to collect on the high risk debt accounts. Responsive to receiving these requests, the purchased debt interface 214 generates the requested forms (for example, as a document encoded according to Portable Document Format) and stores information descriptive of the contents of the generated forms in the purchased data store 202. This content information may include updates to account balances for payments made. This content information may also include indications as to which accounts are eligible for sale, which have been sold, the date accounts have been sold, which accounts have been placed with collection organizations, and the like.

In some embodiments, the purchased debt interface 214 is also configured to provide a bankruptcy portfolio interface that presents information descriptive of the debtor, account and other characteristics of the bankruptcy case.

According to another embodiment, the purchased debt interface 214 is configured to receive one or more reporting requests. In this embodiment, the reporting request may include information descriptive of a report and parameters used to run the report. Responsive to receiving the report request, the purchased debt interface 214 executes the reporting request by retrieving data from the purchased account data store 202, formatting the data according to the report format, and presenting the report via a user interface.

Some examples of reports that may be requested include a bankrupt account evaluation summary, a bankrupt account payment summary, a bankrupt account cost write off payment report, a bankrupt account cost write off sale report, a bankrupt account sale eligible report, a deceased account evaluation summary, a portfolio summary, and a collection vendor report. The bankrupt evaluation summary report presents a summary of the valuations of each portfolio of bankrupt accounts (e.g., estimated return less realized return to date). The bankrupt payment summary report presents a summary of all payments received to date by month & portfolio. The bankrupt cost write off payment report presents a summary of all eligible cost of sale write offs based on payments received to date. The bankrupt cost write off sale report presents a summary of all eligible cost of sale write offs based on account sales. The bankrupt sale eligible report presents a report used to create account information to facilitate bankrupt account sales. The deceased evaluation summary report presents a summary of the valuations of each portfolio of deceased accounts (e.g., estimated return less realized return to date). The portfolio summary report presents the following information for all portfolios: name, face value, purchase price, date purchased, and the like. The collection vendor report presents debt account information used to upload and reconcile deceased accounts with one or more collection vendors.

Other example reports include reports for other high risk debt types that are analogous to those listed above. For instance, an account evaluation summary, account payment summary, account cost write off payment report, a account cost write off sale report, and a account sale eligible report may be generated for each type of high risk debt (e.g., debt settlement accounts, unclaimed funds accounts, cease and desist accounts, and incarcerated accounts). The account evaluation summary report presents a summary of the valuations of each portfolio of accounts (e.g., estimated return less realized return to date). The account payment summary report presents a summary of all payments received to date by month & portfolio. The account cost write off payment report presents a summary of all eligible cost of sale write offs based on payments received to date. The account cost write off sale report presents a summary of all eligible cost of sale write offs based on account sales. The account sale eligible report presents a report used to create account information to facilitate account sales.

Referring again to FIG. 2, the debt monetization system 108 includes and executes the scrubbing engine 204, the liquidation engine 206, and the purchasing engine 216. Each of these engines may periodically execute to process various requests stored by the interface components described above. For example, according to some embodiments, the scrubbing engine 204 periodically searches for unprocessed update requests stored in the owner account data store 200. In these embodiments, in response to identifying one or more unprocessed update requests, the scrubbing engine 204 executes acts requested in the update request, such as the scrubbing processes described above with reference to the available debt interface 212. Both the liquidation engine 206 and the purchasing engine 216 may periodically execute to process other requests described herein (e.g., purchase requests).

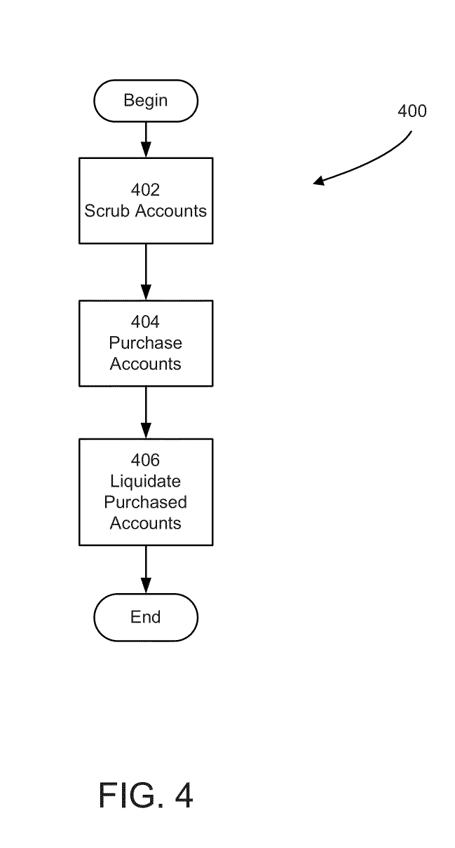

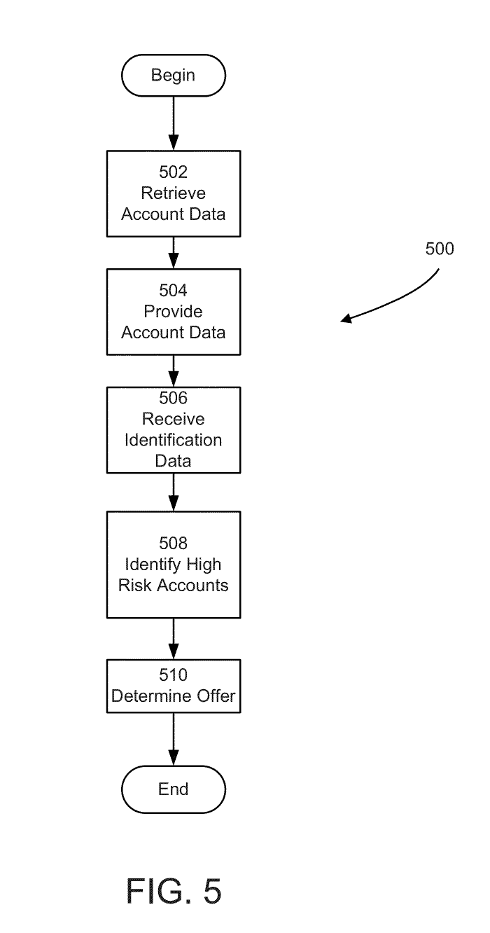

In another embodiment illustrated in FIG. 2, the scrubbing engine 204 is configured to perform a variety of processes that facilitate the identification of high risk debts within a collection of accounts aggregated from a number of owners, such as the owner 110. Exemplary processes performed by the scrubbing engine 204 are described further below with reference to FIGS. 4 and 5. In at least one embodiment, these processes may perform a full scrub or a partial scrub. A full scrub processes all accounts with the exception of previously purchased high risk debt accounts and accounts subject to discharged (or closed) bankruptcies. A partial scrub processes all accounts with the exception of previously purchased accounts and any that were previously identified as bankrupt regardless of status (i.e. this excludes open, reopen, dismissed, etc.).

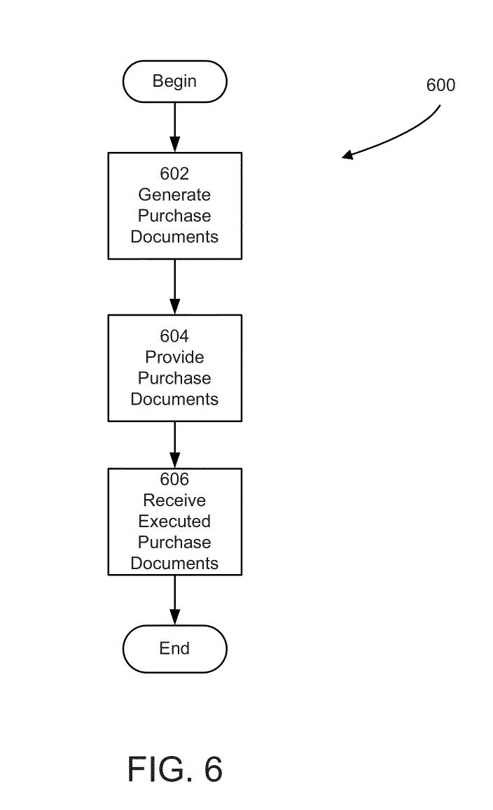

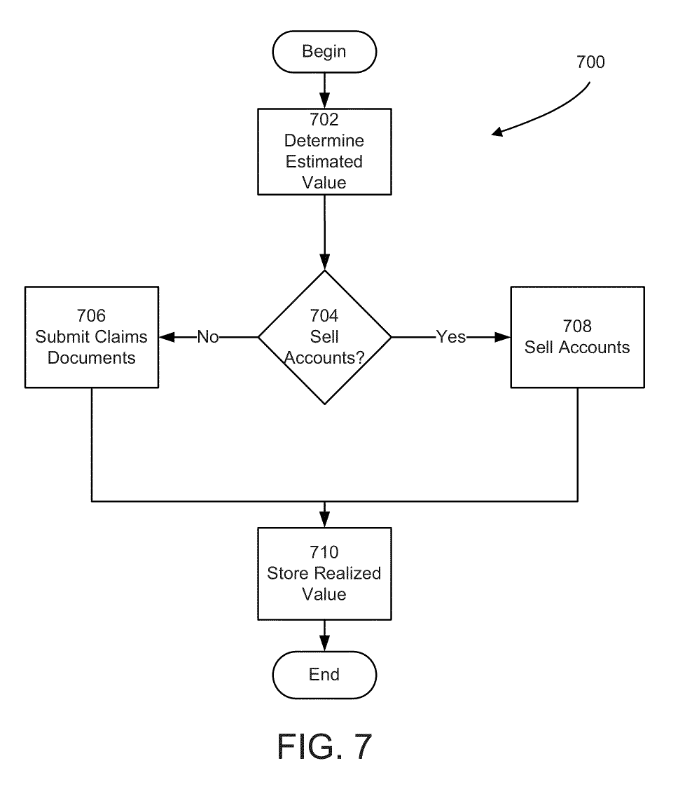

In the embodiment illustrated in FIG. 2, the purchasing engine 216 is configured to perform various processes that facilitate the transfer of ownership of high risk debts from their owners to a purchaser, such as the purchaser 112. Exemplary processes performed by the purchasing engine 216 are described further below with reference to FIGS. 4 and 6. The liquidation engine 206 is configured to perform sundry processes that determine one or more profitable dispositions of purchased high risk debt accounts and that facilitate a selected disposition. During the performance of these processes, the liquidation engine 216 may exchange files and other information with one or more FTP sites accessible by a variety of users, such as the owner 110, the purchaser 112, and the collector 114. Exemplary processes performed by the liquidation engine 216 are described further below with reference to FIGS. 4 and 7.

In the embodiment illustrated in FIG. 2, the debt monetization system 108 implements the owner account data store 200 and the purchased account data store 202. Both of the data stores 200 and 202 include a variety of information descriptive of accounts. This account information may include information identifying the account debtor (e.g., name, address, date of birth, social security number, telephone number, type of legal entity), information descriptive of the account (e.g., date opened, original balance, principal balance, interest fees incurred, interest rate applicable to the account, the loan type of the account, any applicable charge off date, last payment received date, last payment amount, other transaction amounts and dates), information descriptive of the creditor, and an indicator of whether the account is a merchant account. The owner account data store 200 stores account information received from one or more owners. The purchased account data store 202 stores account information for high risk accounts purchased from the one or more owners. The purchased account data store 202 also includes data used to manage the accounts stored within the purchased account data store 202. This account management data includes information descriptive of claim filings, bankruptcy court account management, status updates, payments, portfolio sales, portfolio reporting, and the like.

The data stores 200 and 202 may take the form of any logical construction capable of storing information on a computer readable medium including flat files, indexed files, hierarchical databases, relational databases or object oriented databases. The data may be modeled using unique and foreign key relationships and indexes. The unique and foreign key relationships and indexes may be established between the various fields and tables to ensure both data integrity and data interchange performance. In at least one embodiment, the data stores 200 and 202 are implemented using MICROSOFT ACCESS, which is commercially available from Microsoft Corporation of Redmond, Wash.

Various embodiments may implement the components described above using a variety of hardware components, software components and combinations of hardware and software components. Thus embodiments disclosed herein are not limited to the particular configuration illustrated in FIGS. 1 and 2 and may utilize alternative or additional components configured to perform the processes and functions described herein.

The interfaces disclosed herein exchange information with various providers and consumers. These providers and consumers may include any external entity including, among other entities, users and systems. Each of the interfaces disclosed herein may both restrict input to a predefined set of values and validate any information entered prior to using the information or providing the information to other components. Additionally, each of the interfaces disclosed herein may validate the identity of an external entity prior to, or during, interaction with the external entity. These functions may prevent the introduction of erroneous data into the debt monetization system 108 or unauthorized access to the debt monetization system 108.

### Debt Monetization User Interface Elements

As described above some embodiments disclosed herein provide a variety of user interface elements through which an external entity may interact with the debt monetization system 108. FIGS. 8-14 illustrate examples in accord with these embodiments.

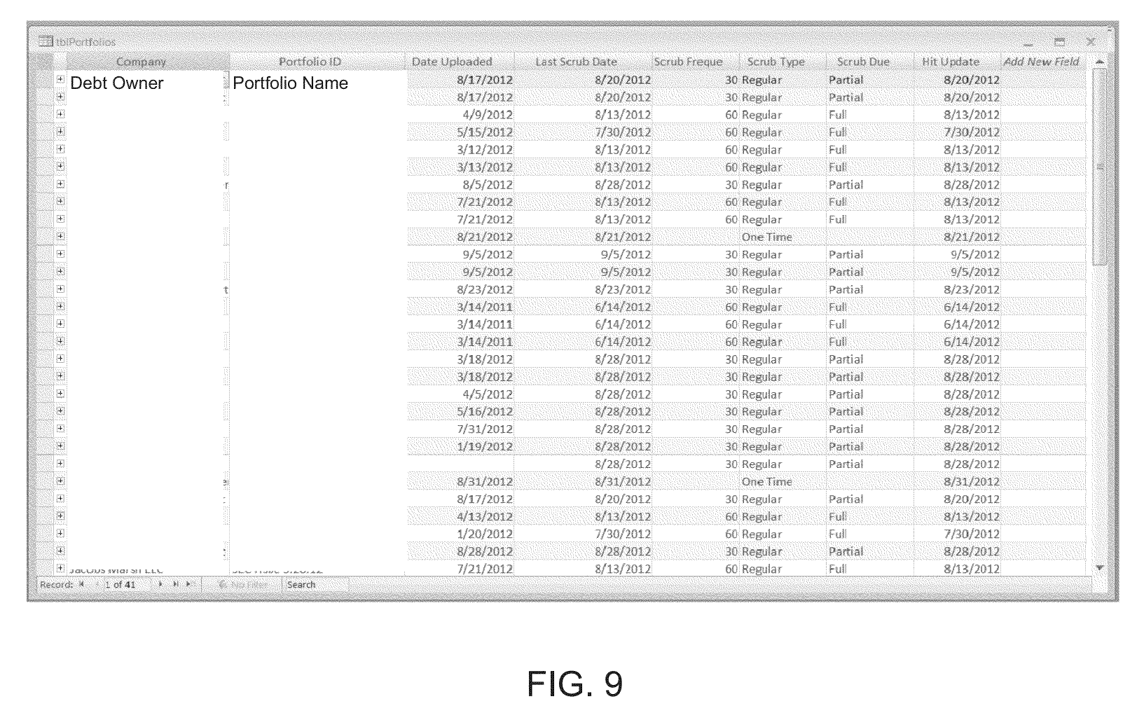

More particularly, the set of user interface elements illustrated in FIG. 8 present the scrubbing processes that are due, when the scrubbing processes should be executed, which type of scrubbing should be executed. FIG. 9 shows a set of user interface elements that present customer portfolios and information about the portfolios that is used to trigger periodic scrubbing processes and account classification.

FIG. 10 illustrates one example of a set of user interface elements, provided by the available debt interface 212, through which the debt monetization system 108 receives a variety of requests. Examples of these requests include requests to add, modify, or delete clients and portfolios; import new portfolios; import high risk debt account scrubbing results; run quality control checks on uploaded portfolios; or move high risk debt accounts from the owner account data store 200 to the purchased account data store 202 (e.g., by executing the purchasing engine 216).

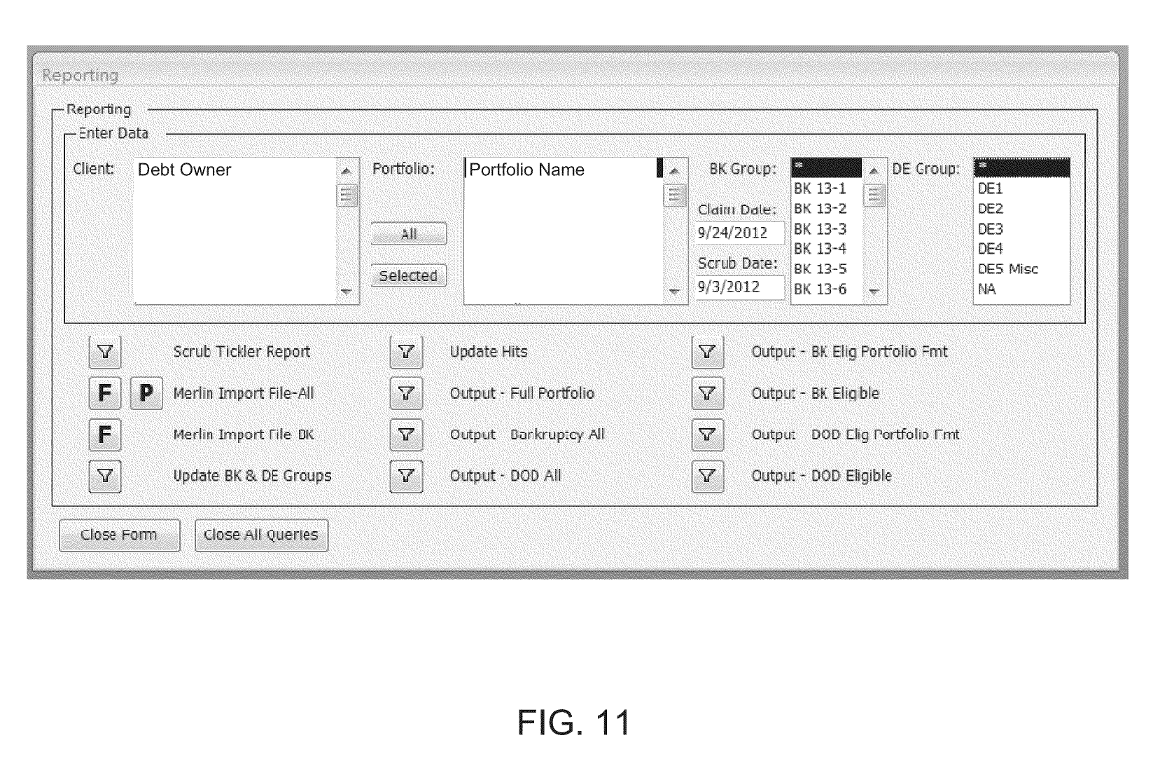

FIG. 11 shows a set of user interface elements through which the debt monetization system 108 receives various requests. Examples of these reporting requests include requests to generate reports of which portfolios need to part of a scrubbing process and when the scrubbing process should be performed. Other examples of the requests processed by the example shown in FIG. 11 include requests to execute an exemplary account data interface 208 in which the account data interface 208 generates a report file including information descriptive of a batch of high risk debt accounts to be processed by the account identification system 106. Still other examples of the requests processed by the example shown in FIG. 11 include requests to update the high risk debt account groupings as well as tag each high risk debt account as a new hit or updated hit. Yet other examples of the requests processed by the example shown in FIG. 11 include requests to execute a series of reports based on the selected owners/portfolios at the top to show full portfolios, bankrupt hits, deceased hits, and eligible high risk debt (e.g., incarcerated, debt collection, unclaimed, cease and desist, bankrupt or deceased account) hits.

FIG. 12 illustrates one example of a set of user interface elements provided by the purchased debt interface 214. In the example shown in FIG. 12, the debt monetization system receives requests to add or modify portfolio names & details, import or remove portfolios, and calculate summary data (e.g. total face value, total cost, etc.). In general, the buttons illustrated on the “Database Options” screen of FIG. 11 (and the buttons illustrated in any of FIGS. 8-14) are configured to initiate performance of the functions described by their label. As shown, labels (e.g., “Enter New Portfolio”) are presented to the right of their corresponding button.

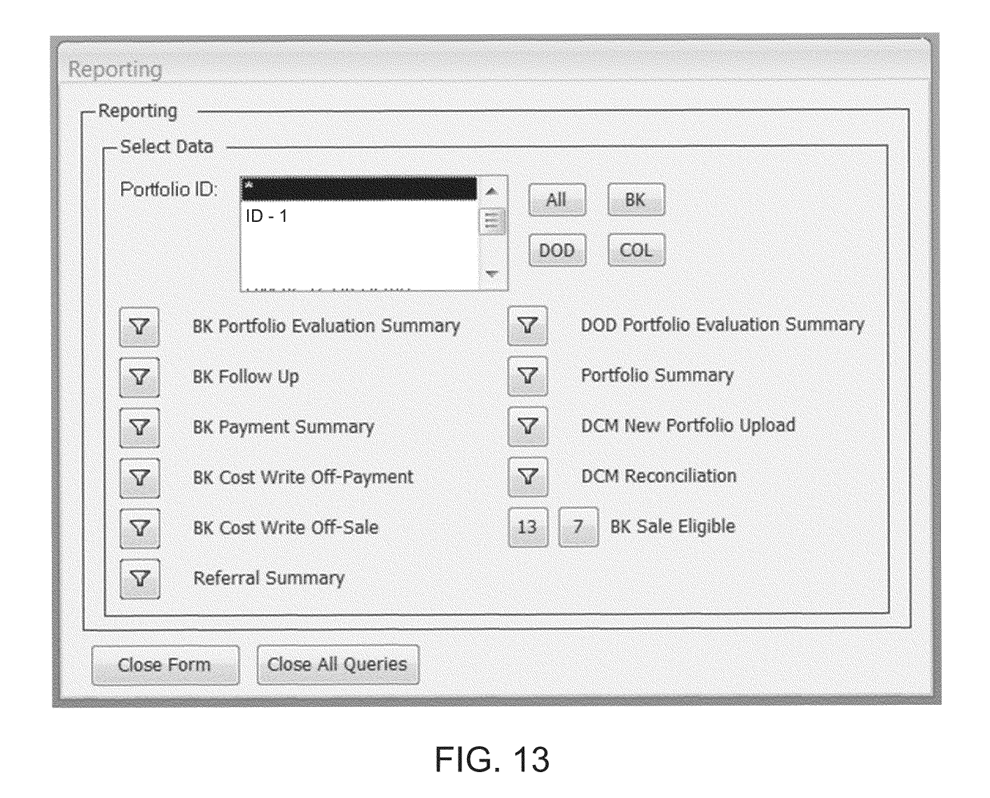

FIG. 13 shows a set of user interface elements through which the debt monetization system 108 receives various report requests. Examples of the reports that may be requested by these requests include summary of evaluations by portfolio, summary of payments received by portfolio, calculated write off amounts based on payments received or accounts sold, review of general information regarding each portfolio, upload reports to send to our deceased collection agency and reports for the resale of chapter 7 and/or 13 portfolios.

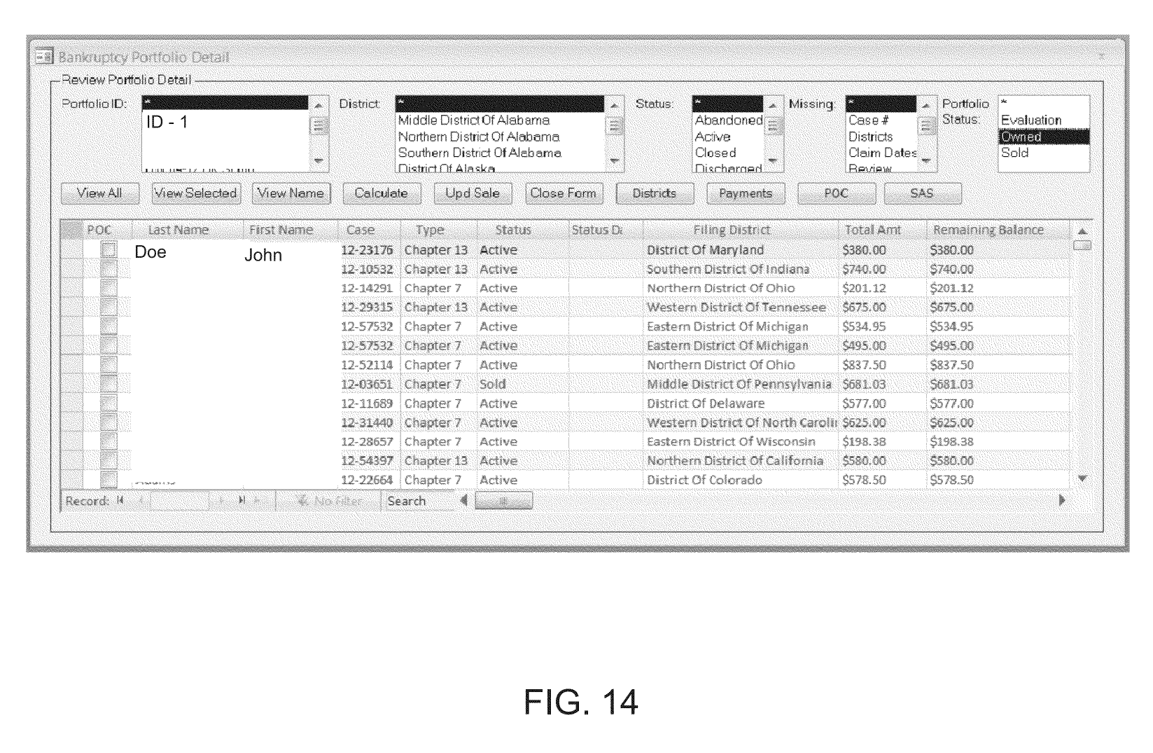

FIG. 14 shows a set of user interface elements through which the debt monetization system 108 receives requests to manage bankrupt account information. The user interface elements presented in FIG. 14 may filter accounts and highlight account specific details in to response to selection of particular options, such as the options at the top and the View All, View Selected and View name buttons. The user interface elements in FIG. 14 may present information descriptive of basic calculates for each account (such as payments received, remaining balance, etc.) and information descriptive of high risk debt accounts that are tagged (identified) as eligible to be sold based on bankruptcy type. The user interface elements in FIG. 14 may also manage court district memberships for electronic filing, manage the payments that are received, and automatically create claim reports needed to file claims electronically.

### Computer System

As discussed above with regard to FIGS. 1 and 2, various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 3, there is illustrated a block diagram of a distributed computer system 300, in which various aspects and functions are practiced. As shown, the distributed computer system 300 includes one more computer systems that exchange information. More specifically, the distributed computer system 300 includes computer systems 302, 304 and 306. As shown, the computer systems 302, 304 and 306 are interconnected by, and may exchange data through, a communication network 308. The network 308 may include any communication network through which computer systems may exchange data. To exchange data using the network 308, the computer systems 302, 304 and 306 and the network 308 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, PHP, JSON, SOAP, CORBA, REST and Web Services. To ensure data transfer is secure, the computer systems 302, 304 and 306 may transmit data via the network 308 using a variety of security measures including, for example, TLS, SSL or VPN. While the distributed computer system 300 illustrates three networked computer systems, the distributed computer system 300 is not so limited and may include any number of computer systems and computing devices, networked using any medium and communication protocol.

As illustrated in FIG. 3, the computer system 302 includes a processor 310, a memory 312, an interconnection element 314, an interface 316 and data storage element 318. To implement at least some of the aspects, functions and processes disclosed herein, the processor 310 performs a series of instructions that result in manipulated data. The processor 310 may be any type of processor, multiprocessor or controller. Some exemplary processors include commercially available processors such as an Intel Xeon, Itanium, Core, Celeron, or Pentium processor, an AMD Opteron processor, an Apple A4 or A5 processor, a Sun UltraSPARC or IBM Power5+ processor and an IBM mainframe chip. The processor 310 is connected to other system components, including one or more memory devices 312, by the interconnection element 314.

The memory 312 stores programs and data during operation of the computer system 302. Thus, the memory 312 may be a relatively high performance, volatile, random access memory such as a dynamic random access memory (“DRAM”) or static memory (“SRAM”). However, the memory 312 may include any device for storing data, such as a disk drive or other nonvolatile storage device. Various examples may organize the memory 312 into particularized and, in some cases, unique structures to perform the functions disclosed herein. These data structures may be sized and organized to store values for particular data and types of data.

Components of the computer system 302 are coupled by an interconnection element such as the interconnection element 314. The interconnection element 314 may include one or more physical busses, for example, busses between components that are integrated within a same machine, but may include any communication coupling between system elements including specialized or standard computing bus technologies such as IDE, SCSI, PCI and InfiniBand. The interconnection element 314 enables communications, such as data and instructions, to be exchanged between system components of the computer system 302.

The computer system 302 also includes one or more interface devices 316 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 302 to exchange information and to communicate with external entities, such as users and other systems.

The data storage element 318 includes a computer readable and writeable nonvolatile, or non-transitory, data storage medium in which instructions are stored that define a program or other object that is executed by the processor 310. The data storage element 318 also may include information that is recorded, on or in, the medium, and that is processed by the processor 310 during execution of the program. More specifically, the information may be stored in one or more data structures specifically configured to conserve storage space or increase data exchange performance. The instructions may be persistently stored as encoded signals, and the instructions may cause the processor 310 to perform any of the functions described herein. The medium may, for example, be optical disk, magnetic disk or flash memory, among others. In operation, the processor 310 or some other controller causes data to be read from the nonvolatile recording medium into another memory, such as the memory 312, that allows for faster access to the information by the processor 310 than does the storage medium included in the data storage element 318. The memory may be located in the data storage element 318 or in the memory 312, however, the processor 310 manipulates the data within the memory, and then copies the data to the storage medium associated with the data storage element 318 after processing is completed. A variety of components may manage data movement between the storage medium and other memory elements and examples are not limited to particular data management components. Further, examples are not limited to a particular memory system or data storage system.

Although the computer system 302 is shown by way of example as one type of computer system upon which various aspects and functions may be practiced, aspects and functions are not limited to being implemented on the computer system 302 as shown in FIG. 3. Various aspects and functions may be practiced on one or more computers having a different architectures or components than that shown in FIG. 3. For instance, the computer system 302 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 302 may be a computer system including an operating system that manages at least a portion of the hardware elements included in the computer system 302. In some examples, a processor or controller, such as the processor 310, executes an operating system. Examples of a particular operating system that may be executed include a Windows-based operating system, such as, Windows NT, Windows 2000 (Windows ME), Windows XP, Windows Vista or Windows 7 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 310 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g. specialized hardware, executable code, data structures or objects, that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Debt Monetization Processes

As described above with reference to FIG. 2, some embodiments perform processes that monetize high risk debts using a distributed computer system, such as the debt monetization system 108. One example of such a debt monetization process is illustrated in FIG. 4. According to this example, the debt monetization process 400 includes acts of scrubbing accounts, purchasing accounts, and monetizing purchased accounts.

In act 402, the debt monetization system scrubs a collection of accounts received from one or more owners by executing a scrubbing engine, such as the scrubbing engine 204 described above with reference to FIG. 2. In some embodiments, the act 402 is performed periodically (e.g., every 30-90 days). Actions in accord with the act 402 are described further below with reference to FIG. 5.

In act 404, the debt monetization system facilitates purchasing of one or more high risk debt accounts identified during execution of the act 402 by executing a purchasing engine, such as the purchasing engine 216 described above with reference to FIG. 2. Actions in accord with the act 404 are described further below with reference to FIG. 6.

In act 406, the debt monetization system facilitates liquidation of one or more high risk debt accounts purchased during execution of the act 404 by executing a liquidation engine, such as the liquidation engine 206 described above with reference to FIG. 2. Actions in accord with the act 406 are described further below with reference to FIG. 7.

As described above with reference to FIG. 4, some embodiments perform processes that scrub a collection of accounts received from a plurality of owners. One example of such a scrubbing process is illustrated in FIG. 5. According to this example, the scrubbing process 500 includes acts of receiving account data, providing the account data to a high risk debt account identifier, receiving identification information that identifies one or more high risk debt accounts, identifying one or more high risk debt accounts within the received account data, and determining whether an offer to purchase the account is warranted.

In act 502, the scrubbing engine retrieves account information from the owner account data store 200. In act 504, where an account identification system, such as the account identification system 106 described above with reference to FIG. 1, processes account information provided to it, the scrubbing engine provides the account information to the account identification system via an identification data interface, such as the identification data interface 210 described above with reference to FIG. 2. In act 506, the scrubbing engine receives identification data from the account identification system via the identification data interface.

In act 508, the scrubbing engine identifies accounts stored in the owner account data store 200 that are indicated as being high risk debt in the identification information received in the act 506. As part of this identification process, the scrubbing engine may store an indication of each newly identified high risk debt account (e.g., information indicating the date on which the account was first identified as high risk). In some embodiments, within the act 508, the scrubbing engine also classifies each high risk debt account into one or more of several predefined groups according to attributes of the high risk debt account. Examples of the attributes referenced by the scrubbing engine during the classification process include whether the debtor who incurred the high risk debt account is deceased, the amount of time elapsed since the death of the debtor, whether the debtor who incurred the high risk debt account is subject to bankruptcy proceedings, whether the debtor who incurred the high risk debt account is incarcerated, whether the debtor who incurred the high risk account is subject to a cease and desist order, whether the debtor who incurred the high risk account is abandoned the account, whether the debtor who incurred the account is working with a debt settlement company, whether the debtor who incurred the high risk debt account owns assets available for liquidation, whether the high risk debt account is in statute, whether the high risk debt account is within the claim date, whether the whether the high risk debt account is subject to a case that is active, whether the high risk debt account is subject to a case that is inactive, and the like. Inclusion of high risk debt accounts into one or more of these predefined groups may indicate that the included high risk debt accounts satisfy (or fail to satisfy) the set of predefined criteria defined in the master agreement described above. In act 510, the scrubbing engine determines whether an offer to purchase each high risk debt account, or each portfolio of high risk debt accounts, is warranted. The scrubbing engine may compute this determination by calculating an estimated return for each high risk debt account.

The estimated return calculation for an individual account may depend on a variety of characteristics associated with the account and the debtor. In some embodiments, these account characteristics include the account attributes enumerated above with reference to act 506. In other embodiments, the account characteristics reflected in the estimated return calculation include the type of the account and the process required to monetize the account. In still other embodiments, the debtor characteristics reflected in the estimated return calculation include income, assets, liabilities, demographic characteristics, financial characteristics, and the like. Further, the calculation may apply different weights to different characteristics. For instance, a first weight may be applied to location, whether it be state, city or zip code, while another weight may be applied to the type of debt, whether it be credit card, student loan, payday loan, etc. Yet another weight might be applied to the length of time since last payment and/or charge off date on the account. Where the estimated return of an account exceeds the cost of purchasing the account by a predefined margin, the scrubbing engine determines that an offer to purchase the account is warranted. Otherwise the scrubbing engine determines that an offer to purchase the account is not warranted. As is described further below, in at least one embodiment, the characteristics and weights utilized by the scrubbing engine to estimate return on individual high risk debt accounts and portfolios are periodically updated as part of the process 700.

In other embodiments, the scrubbing engine determines whether an offer to purchase each high risk debt account is warranted by identifying whether the high risk debt account is a member of one or more of the predefined groups described above with reference to the act 508. In these embodiments, one or more of the predefined groups correspond to the set of predefined criteria that trigger purchase of a high risk debt account as defined in the master agreement. According to these embodiments, the scrubbing engine determines that an offer to purchase is warranted for each account belonging to at least one predefined group that satisfies the set of predefined criteria.

As described above with reference to FIG. 4, some embodiments perform processes that facilitate transfer of ownership of high risk debt accounts identified during execution of the act 402 from the owner to a purchaser, such as the purchaser 112 describe above with reference to FIG. 1. One example of such a purchasing process is illustrated in FIG. 6. According to this example, the purchasing process 600 includes acts of generating purchase documents, providing purchase documents to owners, and receiving executed purchase documents from owners.

In act 602, the purchasing engine generates one or more purchase documents (e.g., a purchase and sale agreement according to the master agreement) with language that effects a transfer of ownership of the accounts for which an offer to purchase was recorded. In act 604, the purchasing engine provides the purchase documents, and the results of the scrubbing process 500 described above, to the owners of the accounts identified in the purchase documents. The purchasing engine may provide this information to the owners via the available debt interface 212.

In act 606, the purchasing engine receives executed versions of the purchase documents and issues payment instructions to the owner according to the terms of the master agreement. Also, in act 606, the purchasing engine transfers account information descriptive of the accounts identified in the purchase documents from the owner account data store 200 to the purchased account data store 202.

As described above with reference to FIG. 4, some embodiments perform processes that liquidate high risk debt accounts purchased during execution of the act 404. One example of such a liquidation process is illustrated in FIG. 7. According to this example, the liquidation process 700 includes acts of estimating a monetary value of a portfolio of high risk debt accounts, determining whether to sell or collect on the portfolio, generating claims documents for accounts identified as being debt incurred by bankrupt parties, selling accounts identified as being debt incurred by deceased parties, storing the realized value of the portfolio, and updating the metrics used to value individual high risk debt accounts and portfolios.

In act 702, the liquidation engine determines an estimated return of collecting on, and to an estimated value of selling, a high risk debt account or a portfolio of high risk debt accounts-. In act 704, the liquidation engine determines whether the estimated collection value is greater than the estimated sales value. If so, the liquidation engine executes act 708. Otherwise, the liquidation engine executes act 706.

In the act 706, the liquidation engine generates and submits claims in a timely manner to meet claim deadlines. According to one embodiment, the liquidation engine manages electronic filing relationships with the bankruptcy courts and probate courts. In this embodiment, the liquidation engine automatically generates claim documents, submits the claim documents, and tracks pending claim submissions in order of urgency. In the act 708, the liquidation engine generates and transmits sales documents to facilitate the sale of the account or portfolio of accounts to a third party. In some embodiments, the liquidation engine requests generation of claims documents via the purchased debt interface 214 described above.

In act 710, after the account, or portfolio of accounts, is liquidated, the realized return resulting from the liquidation is compared to the estimated return and the weights and characteristics utilized to generate estimates are updated. For example, if the actual return proved to be less than the estimated return, the weights are adjusted so that future estimates of accounts with similar characteristics will be lower. Conversely, if the actual return proved to be greater than the estimated return, the weights are adjusted so that future estimate of account with similar characteristics will be higher. In some embodiments, the liquidation engine uses the realized return to provide additional insight into account characteristics that effectively discriminate between accounts with high realization and those with low realization. These characteristics and recommended compensation rates for accounts with these characteristics are provided to the purchaser for use in future master agreements, purchasing documents, and the like.

Processes 400-700 each depict one particular sequence of acts in a particular example. The acts included in these processes may be performed by, or using, one or more computer systems specially configured as discussed herein. Some acts are optional and, as such, may be omitted in accord with one or more examples. For instance, the process 700 may be executed without executing the acts 704, 706, and 708. Additionally, the order of acts can be altered, or other acts can be added, without departing from the scope of the systems and methods discussed herein. Furthermore, as discussed above, in at least one example, the acts are performed on a particular, specially configured machine, namely a debt monetization system configured according to the examples and embodiments disclosed herein.

Having thus described several aspects of at least one example, it is to be appreciated that various alterations, modifications, and improvements will readily occur to those skilled in the art. For instance, examples and embodiments disclosed herein may also be used in other contexts. Such alterations, modifications, and improvements are intended to be part of this disclosure, and are intended to be within the scope of the examples discussed herein. Accordingly, the foregoing description and drawings are by way of example only.

What is claimed is:

1. A computer system comprising:
a memory;
at least one processor coupled to the memory;
an account data interface component executed by the at least one processor and configured to receive account information for accounts owned by a plurality of distinct parties;
a scrubbing engine component executed by the at least one processor and configured to identify a plurality of high risk debt accounts described within the account information; and
a purchasing engine component executed by the at least one processor and configured to identify at least one high risk debt account of the plurality of high risk debt accounts with an estimated return sufficient to warrant purchasing the at least one high risk debt account.

2. The computer system according to claim 1, wherein the scrubbing engine component is further configured to associate each of the plurality of high risk debt accounts with at least one respective debt account type.

3. The computer system according to claim 2, wherein the purchasing engine component is further configured to compute the estimated return using the debt account type associated with the at least one high risk debt account.

4. The computer system according to claim 3, wherein the debt account type is at least one of a bankrupt account type, a deceased account type, debt settlement account type, an unclaimed funds account type, a cease and desist account type and an incarcerated account type.

5. The computer system according to claim 4, wherein the purchasing engine component is further configured to, responsive to identifying the at least one high risk debt account, automatically generate purchase documents including information descriptive of at least one of the plurality of distinct parties who owns the at least one high risk debt account and provide the purchase documents to an external entity for subsequent processing.

6. The computer system according to claim 5, wherein the account data interface component is configured to receive the account information from a plurality of external entities via a network.

7. The computer system according to claim 6, further comprising a liquidation engine component configured to automatically generate and transmit claim documents to an external entity.

8. The computer system according to claim 7, wherein account data interface component is further configured to identify previously purchased high risk debt accounts of the plurality of high risk debt accounts and exclude the previously purchased high risk debt accounts from subsequent processing.

9. A method of monetizing high risk debt using a computer system, the method comprising:
receiving, by the computer system, account information for accounts owned by a plurality of distinct parties;
identifying a plurality of high risk debt accounts described within the account information; and
identifying at least one high risk debt account of the plurality of high risk debt accounts with an estimated return sufficient to warrant purchasing the at least one high risk debt account.

10. The method according to claim 9, further comprising associating each of the plurality of high risk debt accounts with at least one respective debt account type.

11. The method according to claim 10, further comprising computing the estimated return using the debt account type associated with the at least one high risk debt account.

12. The method according to claim 11, wherein associating each of the plurality of high risk debt accounts with at least one respective debt account type includes associating each of the plurality of high risk debts accounts with at least one of a bankrupt account type, a deceased account type, debt settlement account type, an unclaimed funds account type, a cease and desist account type and an incarcerated account type.

13. The method according to claim 12, further comprising:
generating, automatically in response to identifying the at least one high risk debt account, purchase documents including information descriptive of at least one of the plurality of distinct parties who owns the at least one high risk debt account; and
providing the purchase documents to an external entity for subsequent processing.

14. The method according to claim 13, wherein receiving the account information includes receiving account information from a plurality of external entities via a network.

15. The method according to claim 14, further comprising:
generating claim documents; and
transmitting the claim documents to an external entity.

16. The method according to claim 15, further comprising:
identifying previously purchased high risk debt accounts of the plurality of high risk debt accounts; and
excluding the previously purchased high risk debt accounts from subsequent processing.

17. A non-transitory computer readable medium storing instructions executable by at least one processor to perform a method of monetizing high risk debt, the instructions instructing the at least one processor to:
receive account information for accounts owned by a plurality of distinct parties;
identify a plurality of high risk debt accounts described within the account information; and
identify at least one high risk debt account of the plurality of high risk debt accounts with an estimated return sufficient to warrant purchasing the at least one high risk debt account.

18. The computer readable medium according to claim 17, wherein the instructions further instruct the at least one processor to associate each of the plurality of high risk debt accounts with at least one respective debt account type.

19. The computer readable medium according to claim 18, wherein the instructions further instruct the at least one processor to compute the estimated return using the debt account type associated with the at least one high risk debt account.

20. The computer readable medium according to claim 19, wherein the instructions to associate each of the plurality of high risk debt accounts with at least one respective debt account type include instructions that instruct the at least one processor to associate each of the plurality of high risk debts accounts with at least one of a bankrupt account type, a deceased account type, debt settlement account type, an unclaimed funds account type, a cease and desist account type and an incarcerated account type.
